(19) United States
(12) Patent Application Publication
(10) Pub. No.: US 2015/0204682 A1
(43) Pub. Date: Jul. 23, 2015

(54) GPS BASED WATER LOGGING DETECTION AND NOTIFICATION

(71) Applicant: Tata Consultancy Services Limited, Mumbai (IN)

(72) Inventors: Anirban Dutta Choudhury, Kolkata (IN); Amit Kumar Agrawal, Kolkata (IN); Priyanka Sinha, Kolkata (IN); Chirabrata Bhaumik, Kolkata (IN)

(21) Appl. No.: 14/422,284

(22) PCT Filed: Jul. 19, 2013
(86) PCT No.: PCT/IN13/00453

§ 371 Date: Feb. 18, 2015

(30) Foreign Application Priority Data
Aug. 14, 2012 (IN) 2367/MUM/2012

(51) Int. Cl. G01C 21/32

(52) U.S. Cl. CPC G01C 21/32

(57) ABSTRACT

A method and system is provided for determining and displaying least water logging prone route, from a source location to a destination location specified by a user, during a water logging condition in an area. Particularly, the invention provides a method and system for utilizing Global Positioning System (GPS) information including the source and destination location coordinates for determining the at least one alternate route to a user from the at least two routes from the source location to the destination location and rendering result on the user's portable communication device.

The following specification particularly describes the application and the manner in which it is to be performed.

### FIELD OF THE INVENTION

The present invention relates to a method and system for detecting, analyzing and notifying a water logging condition on a road surface. More particularly, the invention provides a method and system for providing a real time map of an area during water logging condition and an all possible alternative routes to the user, during the water logging condition on the road surface.

### BACKGROUND OF THE INVENTION

Water logging typically refers to a situation in which there is a saturation of water at a particular area that may be a road surface or the area near the side of a road. This situation may occur frequently during rainy season or also may occur when there is any breakage of the water pipeline nearby. The problem due to water logging becomes more critical during rainy seasons, when the people are out of their houses, for some work and are unaware of the water logging situation on the road surface on which they are travelling.

The people suffering from the above mentioned situations are mostly pedestrians and sometimes the people travelling through their private vehicles like motorcycle, cars or even in the public transports like buses, auto-rickshaw's or taxies. During rainy season, there are various ways to make people aware about the current situation of the roads outside during heavy rainfall. The ways of awareness may include radio or television broadcast giving static or historic weather updates, the radio or television water logging alerts of the roads or sometimes even the historic data stored at some weather forecasting station may help.

All these ways of awareness mentioned has some or the other limitations, which majorly include that the ways of awareness mentioned, may not cover all the routes of the city and also the historic data updates delivered is not adaptive to current weather information. Secondly, the static water logging data or the semi-dynamic radio or TV water logging alerts covers only the major roads of the city, the other roads are excluded from the updates which sometimes may create problem to the people willing to do some work outside. Some of the existing method and systems known to us are as follows:

U.S. Pat. No. 6,441,748 to Takagi et al. “Road surface condition monitoring system using sensors disposed under the road”, discloses a method and system for road surface monitoring system for monitoring the condition of a road surface that at least one sensor unit is provided in a sealed container disposed below the road surface which stores the already known or pre defined historic weather data.

Another patent application, PCT/AU2000/001416, “A method for providing up-to-date information on road flooding”, discloses a method for providing up-to-date information on road flooding which includes a unit to be positioned at a flooding risk site and the unit having sensor means to detect water height above a predetermined position, sensor means to detect water flow speed and a communication means to communicate the sensor information, the server receiving sensor information from one or more said remote units and recording the information, and able to assign a geographical location to each unit via the unit identifying code means, the server able to provide consumers with up-to-date information as to whether a particular geographical location is closed by flooding. But the application doesn't give any mechanism for any alternative routing information with the area maps after detection of water logging or flood conditions.

Hence there is a need for a method and system, which creates a real time water logging maps based on a global positioning system (GPS) information and making them accessible on the user's communication devices. Further, there is also a need for a method and system for providing provisions for selecting best alternate routes to the people in water logging condition on roads during rainfall.

### OBJECTIVES OF THE INVENTION

In accordance with the present invention, the primary objective is to provide a method and system for capturing altitude information from global positioning system (GPS), for analyzing the low lying areas on the roads, using a communicating portable device.

Another objective of the invention is to provide a method and system for creating a real time water logging maps based on the information captured from the GPS.

Another objective of the invention is to provide a method and system for accepting the information received from the participatory sensors and to use this information for further processing.

Another objective of the invention is to provide a method and system for accepting a source and destination information, received from the communicating portable device of the user.

Another objective of the invention is to provide a method and system for accepting the manual votes from the participatory users.

Another objective of the invention is to provide a method and system for accepting the current rainfall information from the dynamic weather sensors.

Another objective of the invention is to provide a method and system for calculating a confidence matrix (CM) for deciding the water logging hot spots in a particular area.

Another objective of the invention is to provide a method and system for estimating the best possible alternate routes with water logging hot spots and their respective CM's, using a fusion engine.

Another objective of the invention is to provide a method and system for calculating a real time water logging index for each of the routes and thus quantifies water logging information for all the routes.

Yet another objective of the invention is to provide a system and method for displaying the best possible alternate routes with current water logging information.

### SUMMARY OF THE INVENTION

Before the present methods, systems, and hardware enablement are described, it is to be understood that this invention in not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention.

The present invention provides a method and system for finding best possible alternate routes to the destination, provided by a user, during water logging condition in rainy season.

In an embodiment of the invention a method is provided for determining and displaying least water logging prone route, from a source location to a destination location specified by a user, during a water logging condition in an area, comprises capturing a first set of Global Positioning System (GPS) information by using at least one position sensor embedded in a portable communication device, the first set of GPS information comprising the source location coordinates, and the destination location coordinates; and mapping at least two routes from the source location to the destination location using the portable communication device; transmitting the captured first set of GPS information to a fusion server via a communication network by the portable communication device, wherein the fusion server is further configured to capture a second set of GPS information and quantify the second set of information using a confidence matrices module; and determining the at least one alternate route to the user from the at least two routes from the source location to the destination location by mapping the first set of GPS information with the quantified second set of GPS information and rendering a result on the portable communication device in route map, which comprises of the possible routes with water logging condition.

In an embodiment of the invention a system is provided for determining and displaying least water logging prone route, from a source location to a destination location specified by a user during a water logging condition in a particular area, comprises of a portable communication device, adapted to capture an location information from a plurality of altitude information transmitters; at least one processor inside a fusion server operable to provide a possible alternate route map associated with the said user location, and find a severity of the water logging hot spot area on the suggested routes of the route map and in the destination location specified by the said user; a fusion engine module inside the fusion server, adapted to determine an confidence matrices for the said water logging hot spot area by considering the severity of the water logging of the said area and the suggested routes of the route map, a rainfall information from a plurality of dynamic weather sensors, a manual vote by a plurality of participatory users for taking decision of the water logging results by overriding the automatic calculation, and an historical statistics of a plurality of known water logging prone areas.

The above said system and method are preferably for providing best possible alternate routes, with current water logging information, on a communicating portable device of the user but also may be used for many other applications.

### BRIEF DESCRIPTION OF THE DRAWINGS

The foregoing summary, as well as the following detailed description of preferred embodiments, is better understood when read in conjunction with the appended drawings. Drawings and illustrations described herein are intended to lay more emphasis on understanding the underlying principle of the invention. The manner in which the drawings are presented in no way limit the scope of the invention and the advantages one can garner from the embodiments of the present invention. In the drawings:

FIG. 1: shows a flow diagram of the process for water logging detection and displaying all the routes to a destination using a fusion engine.

FIG. 2: shows a flow diagram of water logging detection at the fusion engine.

FIG. 3: shows a system diagram for water logging detection and displaying all the routes to a destination using a fusion engine.

FIG. 4: shows a system diagram for process for water logging detection and displaying all the routes to a destination using a fusion engine.

### DETAILED DESCRIPTION OF THE INVENTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The disclosed embodiments are merely exemplary of the invention, which may be embodied in various forms.

The present application provides a method for determining and displaying at least one least water logging prone route, from a source location to a destination location specified by a user, during a water logging condition in an area, comprises:
a) capturing a first set of Global Positioning System (GPS) information by using at least one position sensor embedded in a portable communication device, the first set of GPS information comprising the source location coordinates, and the destination location coordinates; and mapping at least two routes from the source location to the destination location using the portable communication device;
b) transmitting the captured first set of GPS information to a fusion server via a communication network by the portable communication device, wherein the fusion server is further configured to capture a second set of GPS information and quantify the second set of information using a confidence matrices module; and
c) determining the at least one alternate route to the user from the at least two routes from the source location to the destination location by mapping the first set of GPS information with the quantified second set of GPS information and rendering a result on the portable communication device in route map, which comprises of the possible routes with water logging condition.

The present application provides a system for determining and displaying at least one least water logging prone route, from a source location to a destination location specified by a user during a water logging condition in a particular area, comprises of:
a) a portable communication device, adapted to capture an location information from a plurality of altitude information transmitters;
b) at least one processor inside a fusion server operable to
   i) provide a possible alternate route map associated with the said user location, and
   ii) find a severity of the water logging hot spot area on the suggested routes of the route map and in the destination location specified by the said user;
c) a fusion engine module inside the fusion server, adapted to determine an confidence matrices for the said water logging hot spot area by considering
   i) the severity of the water logging of the said area and the suggested routes of the route map,
   ii) a rainfall information from a plurality of dynamic weather sensors,
   iii) a manual vote by a plurality of participatory users for taking decision of the water logging results by overriding the automatic calculation, and
   iv) an historical statistics of a plurality of known water logging prone areas.

The subject matter of the present application is applicable to any type of electronic equipment such as servers, networking equipment, telecommunications equipment etc. arranged in any fashion.

The word water logging may be considered in similar reference to the word “waterloging” or “water-logging” and the like.

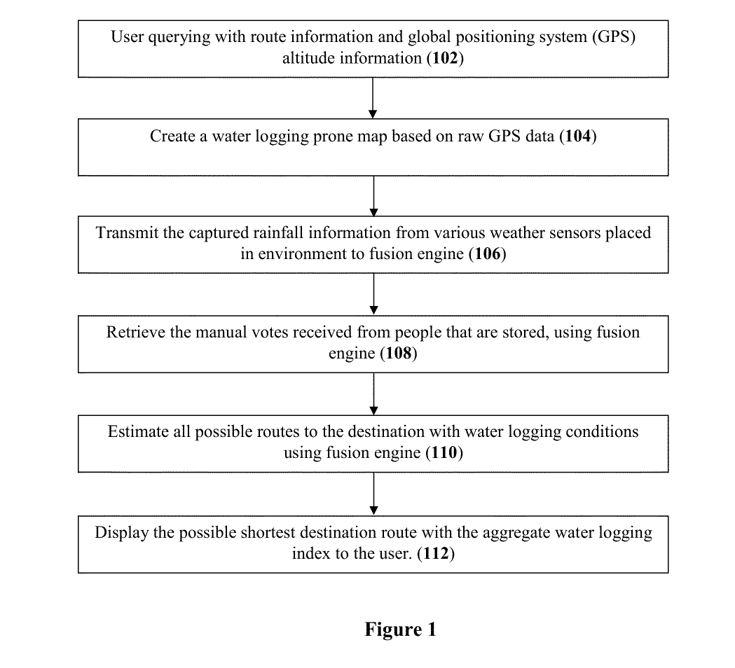

Referring to FIG. 1 is a flow diagram of the process for water logging detection and displaying all the routes to a destination using a fusion engine.

The process starts at the step 102, in which a user provides a query with a route information and global positioning system information, for obtaining all the possible routes to a destination. The route information may be comprised of source information of the current location of the user and destination information to which user is willing to stop. At the step 104, water logging prone map is created by using the information given by step 102. At the step 106, the rainfall information captured from a plurality of weather sensors that are placed in environment, is transmitted to a fusion engine. At the step 108, the manual votes received from the people which are stored, is retrieved by the fusion engine. At the step 110, the fusion engine estimates the entire possible route to the destination along with a water logging condition of all the estimated routes. The process ends at the step 112 in which the possible shortest destination route with aggregate water logging index is displayed on a portable communication device of the user.

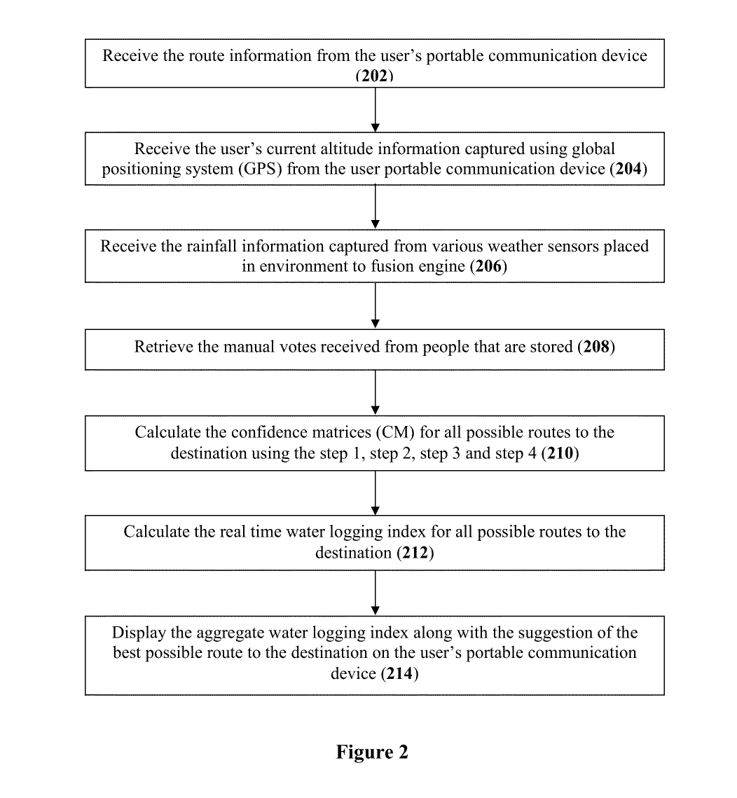

Referring to FIG. 2 is a flow diagram of water logging detection at the fusion engine.

The process starts at the step 202, in which route information, which comprises of a source and destination information, is received at a fusion engine form a user's portable communication device. At the step 204, the user's current altitude information, which is captured using the user's portable communication device, from a global positioning system (GPS), is received at the fusion engine. At the step 206, rainfall information which is captured from a plurality of weather sensors placed in environment is received at the fusion engine. At the step 208, the manual votes received from the people which are stored, is retrieved by the fusion engine. At the step 210, a confidence matrix (CM) for all possible routes to the destination is calculated using the steps 202, 204, 206 and the step 208. At the step 212, a real time water logging index for all possible routes to the destination is calculated. The process ends at the step 214 in which an aggregate water logging index along with the suggestion of a best possible route to the destination is displayed on the user's portable communication device.

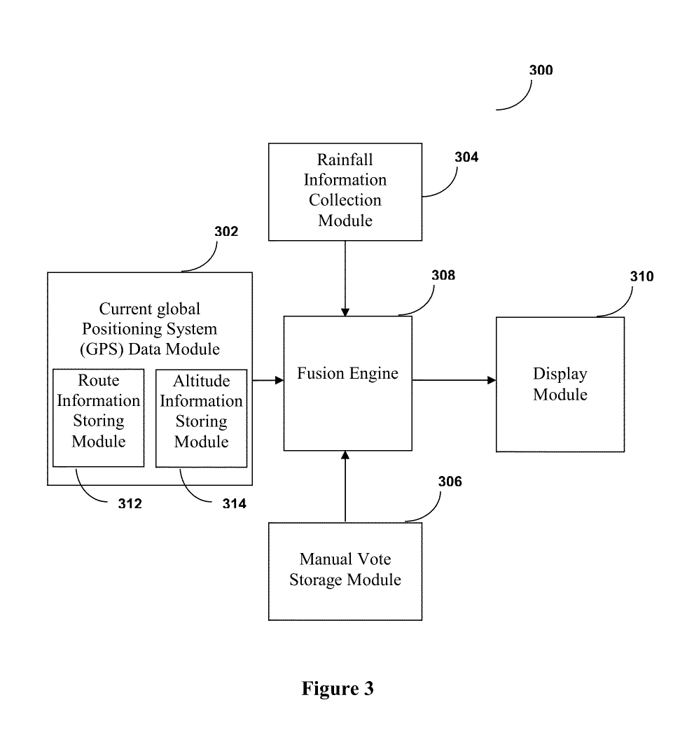

Referring to FIG. 3 is a system diagram for water logging detection and displaying all the routes to a destination using a fusion engine.

In an embodiment of the invention, the said system (300) for estimating and displaying all the routes to the destination using a fusion engine comprising a current global positioning system (GPS) data module (302), which further comprises of a route information storing module (312) and an altitude storing information module (312), a rainfall information collection module (304), a manual vote storage module (306), a fusion engine (308) and a display module (310).

The system and method of the present invention describes estimation of all the possible alternate routes to the destination prescribed by the user. It should be noted that following discussion only illustrates one of the procedures to be used. These procedure may need some modification, some parts may be added, removed or the process may be used iteratively while actual use. Some of the steps may involve offline work to be carried out. For example, storing of the rainfall information from a plurality of weather sensors placed in environment, hence this storing may be done offline. The information of these sensors is then retrieved for use during actual operation of the presented system and method. Similarly, the manual votes taken from various people are also stored in offline mode and then these votes are then used during actual operation of the presented system and method.

In an embodiment of the invention, the current global positioning system (GPS) data module (302) is adapted to store the information which is to be given to the fusion engine (308) for processing. The current global positioning system (GPS) data module (302) further comprises of the route information storing module (312) and the altitude information storing module (314).

In an exemplary embodiment of the present invention, the route information storing module (312) is further adapted to store the current location information inputted by the user while querying for finding alternate routes. The information inputted by the user may include the current source location information and the destination information where user is supposed to reach.

In an exemplary embodiment of the present invention, the altitude information storing module (314) is further adapted to store the altitude information in order to determine the physical location of the user and then height of the user based on GPS altitude data. The information captured may disclose the geographic location of a user or attaining of the current position of user or disclosing the actual coordinates of the user. The GPS altitude information may be obtained using various ways which may include google maps, global positioning system (GPS), optical tracking or even global information systems or wearable tactical system (WTS) or a geographic information system (GIS) and the like.

In an exemplary embodiment of the present invention, the altitude information may be used to create a water logging prone map. GPS altitude information may be accumulated using mobile handheld devices like smart phones. The altitude part of the GPS data may be mapped with the location part of the GPS i.e. route of the journey.

In an embodiment of the invention, the rainfall information collection module (304) is adapted to store all the information captured from a plurality of weather sensors placed in the environment. The plurality of weather sensors may be the dynamic weather sensors which may be any one of a barometric sensor for measuring atmospheric pressure or a hygrometric sensor for measuring humidity or a rain gauge or rain witch or rain sensors for measuring precipitation over a set period of time or a disdromentric sensor for measuring a drop size distribution and the like.

In an embodiment of the invention, the manual vote storage module (306) is adapted to store the manual votes given by the various peoples may be based on their previous experiences related to water logging. The manual vote may also contain the history which will encompass historically known water-logging-prone zones for example static databases maintained by government/private agencies. These areas can be further refined to pin-point water logging hotspots.

In an embodiment of the invention, the fusion engine (308) is adapted to estimate all the possible routes with water logging hot spots and their respective confidence metrics (CM). The fusion engine is further adapted to calculate a real time aggregate water logging index for each of the estimated routes. The fusion engine further suggests quantitatively better route(s) to the end user.

In an exemplary embodiment of the present invention, the Confidence matrices (CM) may be calculated for water clogging hotspots. The matrix may contain two columns with normalized numbers and locations. The numbers demonstrate the probability of the water logging for that respective location. The CM may be calculated based on the inputs which comprises of local minima detection, the rainfall information collection module (304), the manual vote storage module (306).

In an exemplary embodiment the confidence matrices (CM) include the confidence scores for each route. The confidence score may be calculated by below mentioned two methods. In the first method, the severity of a waterloging prone zone may depend on two main factors viz. the range/length of the waterlogged area and the depth of the logged water. To quantify the confidence score for each low lying location detected, the area inside the low lying location is calculated using water reservoir principle. According to the water reservoir principle if the water is poured from top of a 2D curve, the cavity regions of the curve where water will be stored are considered as reservoirs. The area of this reservoir is a measure of the severity of the waterloging problem, and hence directly translates into the confidence score associated to the respective low lying location. While in the second method, approximation of the confidence score may be calculated by assuming that the low lying location is small enough and approximating the area of the low lying location by the area of the largest triangle which can fit into that low lying location. In order to achieve this, the immediate preceding and succeeding peaks for each low lying location may be detected. Then, for each low lying location, the nearest low altitude peak can be chosen and thus may form an isosceles triangle with its base horizontal to the distance axis. This triangle may effectively fills up the reservoir of the respective low lying location.

In an exemplary embodiment of the present invention, the local minima detection algorithm may be used to point out the severity of the water-logging-hot-spots in the particular region. For example, a range of 10 km road is historically known as water infested area. The distinctive local minima(s) in the altitude curve will be more prone to water logging in the entire route.

In an exemplary embodiment of the present invention, the real time aggregate water logging index for each of the estimated routes is calculated.

In an embodiment of the invention, the display module (310) is adapted to display the real time aggregate water logging index for each of the estimated routes and further displays the suggested quantitatively better route(s) to the end user.

In an exemplary embodiment of the present engine, the display may be of any device from the group of devices which comprises of any hand held device or it may be installed in car or may be a desktop display.

In an exemplary embodiment of the present engine, the hand held device may be at least one of an enterprise digital assistant or a mobile computer or a mobile phone or tablet computer or a Smartphone or a personal navigation device or a pager or a cell phone or a laptop or a ultra-mobile PC or a pocket PC.

The user may comprise a pedestrian with Smartphone, a computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that user.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

### Working Example of the Present Invention

In an exemplary embodiment of the present invention, method and system is provided for water logging detection and displaying all the routes to a destination using a fusion engine.

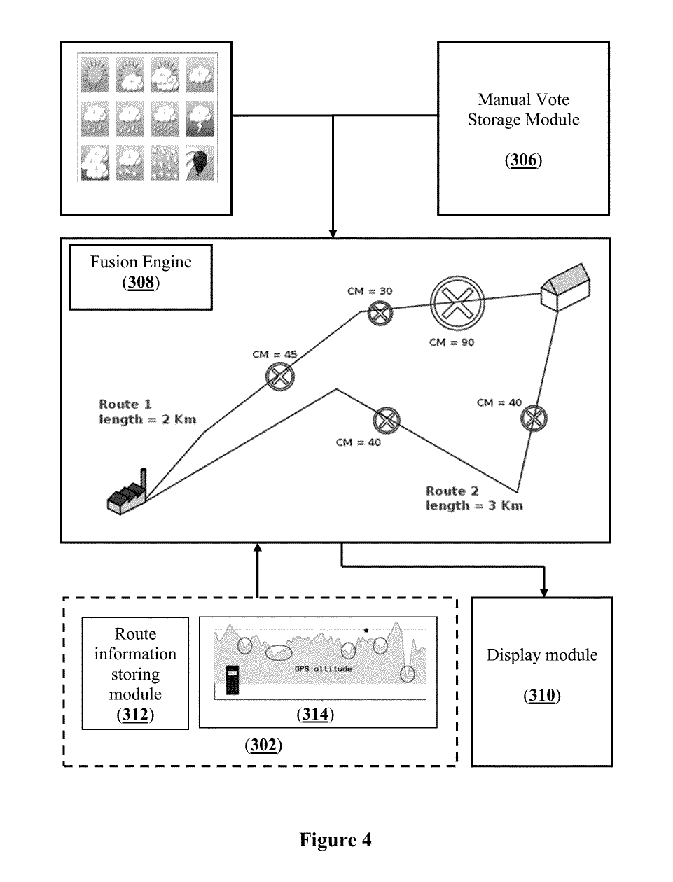

Referring to FIG. 4 is a system diagram for process for water logging detection and displaying all the routes to a destination using a fusion engine.

The water logging detection process starts with the current global positioning system (GPS) data module (302) which is adapted to store the input information for the fusion engine (308) for further processing. The user may capture the GPS altitude information through the portable communication device using altitude information storing module (314). The portable communication device may be selected from the group comprising of smart phones, laptop, tablet, PDA etc. The altitude information stored in altitude information storing module (314) of the GPS data is mapped with the location information stored in route information storing module (312) of the GPS i.e. route of the journey. Assisted GPS and other filtering methods are used to “snap” the data with streets.

In a typical rain infested region, the drainage system is not functional enough to evacuate the logged water in a reasonable time. It's most likely that in that region, lower the GPS location, higher is the probability of water logging. So a local minima detection algorithm may point out the severity of the water-logging-hot-spots in that region. The confidence matrices (CM) are calculated for water clogging hotspots inside a fusion engine (308). An input for confidence matrices calculation inside a fusion engine (308) includes Local minima detection from the fusion engine, multiple GPS data from different mobile devices are collected to build a normalized collection of available/popular GPS receivers, recent rainfall information which may include information of last 24-48 hour from dynamic weather sensors stored in rainfall information collection module (304). The manual vote storage module (306) encompasses information pertaining to the historically known water-logging-prone zones e.g. static databases maintained by government/private agencies. These areas may be further refined to pin-point water-logging hotspots. The manual vote storage module (306) by a participatory user will directly affect the present CM of that GPS location. E.g. manual voting may be used to rule out the decision of false positive(s).

The user sends the current GPS information stored in current global positioning system (GPS) data module (302) to the fusion engine (308) including route information (source and destination) and current GPS data i.e. current location stored in route information storing module (312) and altitude information altitude information storing module (314). This input is needed to determine the altitude difference of the end user E.g. pedestrian/small car or big car/bus (from the GPS altitude data). There might be water logging cases which a bus may ignore, but a pedestrian can not ignore. This may be an optional input. A static user does not need to send it. The user can still get the real-time waterlogging CM(s) for a certain route.

In return, the fusion engine output displays the possible route(s) with water logging hotspots and their respective CMs using display module (310). It also calculates a real-time aggregate water logging index for each of the routes and thus quantifies water logging information for all the routes. Thus, suggests quantitatively better route(s) to the end user. The calculated CM and aggregate water logging index is given in FIG. 4 with the displayed output on the display screen using display module (310) to the user, suggesting best possible route.

1. A method for determining and displaying at least one least water logging prone route, from a source location to a destination location specified by a user, during a water logging condition in an area, comprising:
capturing a first set of Global Positioning System (GPS) information by using at least one position sensor embedded in a portable communication device, the first set of GPS information comprising source location and destination location coordinates, and mapping at least two routes from the source location to the destination location using the portable communication device;
transmitting the first set of GPS information to a fusion engine by the portable communication device;
receiving, from the fusion engine, at least one alternate route from the source location to the destination location, the alternate route determined among the at least two routes by mapping the first set of GPS information with a second set of GPS information, the second set of GPS information captured and quantified by the fusion engine using a confidence matrices module; and
displaying, on the portable communication device, the at least one alternate route in a route map along with possible routes with a water logging condition.

2. The method of claim 1, wherein the at least one position sensor comprises at least one of a global positioning system (GPS), a global information system, a geographic information system (GIS), or a combination thereof.

3. The method of claim 1, wherein the second set of GPS information comprises at least one of a normalized statistical data pertaining to real-time water logging at the particular location collected from at least one participatory device, information pertaining to recent rain-fall captured by the fusion server from dynamic rain sensors, a historical data set, a vote projected by the at least one participatory device, or a combination thereof.

4. The method of claim 3, wherein the at least one participatory device comprises:
a location sensor; and
a communication means for projecting a vote.

5. The method of claim 3, wherein the confidence matrices module includes normalized values and locations the values demonstrating a probability of water logging for each respective location.

6. The method of claim 5, wherein the second set of data is quantified for each of the at least two routes and rendered on a display of the portable communication device for the user.

7. The method of claim 3, wherein the dynamic rain sensors include at least one of a barometric sensor for measuring atmospheric pressure, a hygrometric sensor for measuring humidity, a rain gauge or rain witch or rain sensors for measuring precipitation over a set period of time, a disdromentric sensor for measuring a drop size distribution or combination thereof.

8. A system for determining and displaying at least one least water logging prone route, from a source location to a destination location specified by a user during a water logging condition in a particular area, comprising:
a fusion engine to:
receive altitude information from a portable communication device, the altitude information captured by the portable communication device using a plurality of altitude information transmitters,
estimate routes from a source location to a destination location specified by the a user, the routes including one or more possible water logging hot spots,
determine confidence matrices for the water logging hot spots based on:
the severity of water logging of each water logging hot spot, the severity determined based on the received altitude information,
rainfall information received from a plurality of dynamic weather sensors,
votes received from a plurality of participatory users for overriding confidence matrices determined by the fusion engine, and
historical statistics of a plurality of known water logging prone areas; and
determine at least one alternate route from the source location to the destination location based on the estimated routes and determined confidence matrices.

9. The system of claim 8, wherein water logging includes at least one of saturation of soil by groundwater, saturation of water on a road due to rainfall, saturation of water on a road due to flood or a damaged drainage system, insufficient drainage system, or combination thereof.

10. The system of claim 8, wherein the user is at least one of an operator of a vehicle, a pedestrian, a dispatcher, or any independent entity.

11. The system of claim 8, wherein the portable communication device is at least one of an enterprise digital assistant, a mobile computer, a mobile phone, a tablet computer, a Smartphone, a personal navigation device, a pager, a cell phone, a laptop, an ultra-mobile PC, or a pocket PC.

12. The system of claim 8, wherein the altitude information transmitters are at least one of a global positioning system (GPS), a global information system, a wearable tactical system (WTS), or a geographic information systems (GIS).

13. The system of claim 8, wherein the altitude information includes a geographic location of a user.

14. The system of claim 8, wherein the estimated routes are included in a route map.

15. The system of claim 14, wherein the route map depicts a visual representation of a physical location of the user and the one or more water logging hot spots and their respective confidence matrices.

16. An apparatus for determining and displaying at least one water logging prone route, comprising:
a portable communication device, including:
at least one position sensor communicably connected to a processor to capture a first set of GPS information comprising source location and destination location coordinates,
a processor to:
transmit the first set of GPS information to a fusion engine, and
receive, from the fusion engine, at least one alternate route from the source location to the destination location, the alternate route determined by mapping the first set of GPS information with a second set of GPS information captured and quantified by the fusion engine using a confidence matrices module; and
a display to display the at least one alternate route in a route map along with possible routes with a water logging condition.

17. (canceled)

18. (canceled)

19. The apparatus of claim 16, wherein the at least one position sensor comprises at least one of a global positioning system (GPS), a global information system, a geographic information system (GIS), or a combination thereof.

20. The apparatus of claim 16, wherein the portable communication device is at least one of an enterprise digital assistant, a mobile computer, a mobile phone, a tablet computer, a Smartphone, a personal navigation device, a pager, a cell phone, a laptop, an ultra-mobile PC, or a pocket PC.
